(19) United States
(12) Patent Application Publication
(10) Pub. No.: US 2012/0085227 A1
(43) Pub. Date: Apr. 12, 2012

(54) LATCHING ASSEMBLY FOR AN ACCUMULATOR

(75) Inventors: Carlos E. Marin, Oxford, MI (US); Leonid Basin, Farmington Hills, MI (US)

(73) Assignee: GM GLOBAL TECHNOLOGY OPERATIONS LLC, DETROIT, MI (US)

(21) Appl. No.: 13/185,331

(22) Filed: Jul. 18, 2011

Related U.S. Application Data
(60) Provisional application No. 61/391,320, filed on Oct. 8, 2010.

(51) Int. Cl. F15B 15/26

(52) U.S. Cl. 92/23

(57) ABSTRACT

An accumulator assembly includes a pressure canister and a latching assembly. The latching assembly includes a solenoid, an actuator, and a piston. The piston is slidingly engaged within an interior space the canister. The piston divides the interior space of the canister into an air chamber and a fluid filled chamber. The fluid filled chamber is in fluid communication with a fluid supply line. A biasing member is located within the air filled chamber and exerts a biasing force on the piston. The solenoid induces a magnetic field used to actuate the actuator, where the actuator selectively engages with a groove located along an outer surface of the piston. When the actuator disengages from the groove, the biasing force exerted by the biasing member urges the piston to slide within the canister, causing fluid to discharge from the fluid chamber and into the supply line.

### CROSS REFERENCE TO RELATED APPLICATION

This application claims the benefit of U.S. Provisional Patent Application Ser. No. 61/391,320, filed Oct. 8, 2010, which is hereby incorporated in its entirety herein by reference.

### FIELD

The present invention relates to an accumulator, and more particularly to an accumulator having a latching assembly for regulating fluid to and from the accumulator.

### BACKGROUND

The statements in this section merely provide background information related to the present disclosure and may or may not constitute prior art.

A typical automatic transmission includes a hydraulic control system that, among other functions, is employed to actuate a plurality of torque transmitting devices. These torque transmitting devices may be, for example, friction clutches and brakes. The conventional hydraulic control system typically includes a main pump that provides a pressurized fluid, such as oil, to a plurality of valves and solenoids within a valve body. The main pump is driven by the engine of the motor vehicle. The valves and solenoids are operable to direct the pressurized hydraulic fluid through a hydraulic fluid circuit to the plurality of torque transmitting devices within the transmission. The pressurized hydraulic fluid delivered to the torque transmitting devices is used to engage or disengage the devices in order to obtain different gear ratios.

One problem with hydraulically actuated clutches is if the engine is turned off, it may become difficult for the transmission pump to supply fluid to the clutches. It may be especially difficult to actuate clutches in a hybrid drivetrain when the engine or prime mover is turned off and an electric motor is used to propel the vehicle. A separate auxiliary electric pump may be included with the drivetrain for providing pressurized hydraulic fluid when the IC engine is turned off. However, these auxiliary electric pumps can add to the cost, weight and complexity of a vehicle. Accordingly, there is a need in the art for a cost-effective hydraulic system that supplies fluid to a clutch when an engine is not operating.

### SUMMARY

An accumulator assembly is provided including a pressure canister and a latching assembly. The latching assembly includes a solenoid, an actuator, and a piston. The piston is slidingly engaged within an interior space of the canister. The piston divides the interior space of the canister into an air chamber and a fluid filled chamber. The fluid filled chamber is in fluid communication with a fluid supply line. A biasing member is located within the air filled chamber and exerts a biasing force on the piston. The solenoid induces a magnetic field used to actuate the actuator, where the actuator selectively engages with a groove located along an outer surface of the piston.

When the actuator is engaged with the groove located on the piston, the piston is in a locked position and is unable to slide within the interior space of the canister, thereby allowing fluid to be retained within the fluid chamber. When the actuator disengages from the groove, the biasing force exerted by the biasing member urges the piston to slide within the canister, causing fluid to discharge from the fluid chamber and into the supply line.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an exemplary accumulator assembly having a piston that is movable within a canister, where the piston is in a seated position within the canister;

FIG. 2 is an illustration of the piston being urged out of the seated position within the canister; and

FIG. 3A is an illustration of the piston engaged with an actuator in a locked position;

FIG. 3B is an alternative embodiment of the actuator illustrated in FIG. 3A;

FIG. 4 is an enlarged view of the actuator illustrated in FIG. 3A; and

FIG. 5 is an enlarged view of the of the accumulator assembly shown in FIG. 2.

### DETAILED DESCRIPTION

The following description is merely exemplary in nature and is not intended to limit the present disclosure, application, or uses.

With reference to FIG. 1, an accumulator assembly is generally indicated by reference number 10. The accumulator 10 is an energy storage device in which a non-compressible hydraulic fluid is held under pressure by an external source. In one exemplary embodiment, the accumulator 10 is positioned in a hydraulic control system of an automatic transmission (not shown), where a pump (not shown) is operatively connected to an engine or a prime mover for supplying hydraulic fluid to the transmission when the engine is operating, and is idle when the engine is turned off. The accumulator 10 collects hydraulic fluid when the engine or a prime mover is operating, retains hydraulic fluid when the engine is turned off, and discharges hydraulic fluid when the engine is restarted. However, those skilled in the art will appreciate that the accumulator 10 may be employed in various other environments, such as fuel injectors, air conditioning systems, etc., without departing from the scope of the present invention.

The accumulator 10 includes a pressure canister 12 and an end cap 14. The pressure canister 12 is generally cylindrical in shape and includes an open end 16 and a closed end 18 opposite the open end 16. A supply line 20 is received within a cavity or passageway 22 that is defined by the pressure canister 12. The supply line 20 includes a first end 24 and a second end 26, where the first end 24 connects to a control system of an automatic transmission (not shown), and the second end 26 of the supply line 20 is received by the cavity 22. The canister 12 includes an interior space 28, and the open end 16 of the canister 12 is sealed by the end cap 14.

The canister 12 includes a piston 34 located within the interior space 28 that is slidingly engaged with an inner surface 36 of the canister 12. A first outer face or surface 42 of the piston 34 and an inner surface 46 of the end cap 14 define an air filled chamber 48. A second outer face or surface 44 of the piston 34 and the inner surface 36 of the canister 12 define a fluid filled chamber 50. The piston 34 divides the interior space 28 of the canister 12 into the air chamber 48 and the fluid filled chamber 50. FIG. 1 illustrates the piston 34 in a seated position where the second outer surface 44 of the piston 34 is seated on an end 52 of the canister 12. The piston 34 is held in the seated position against the end 52 by at least one biasing member 54. In the embodiment as shown, two biasing members 54 are employed. Each biasing member 54 includes a first end 56 and a second end 58, where the first end 56 of the biasing member 54 is engaged with the end cap 14 and the second end 58 of the biasing member 54 is engaged with the first outer surface 42 of the piston 34. The biasing member 54 exerts a biasing force BF in a direction towards the piston 34, thereby keeping the piston 34 seated on the end 52 of the canister 12. In the embodiment as illustrated, the biasing members 54 are both coil springs, however those skilled in the art will appreciate that the piston 34 may be actuated by other approaches as well. For example, in an alternative embodiment the piston 34 is actuated by a compressive gas.

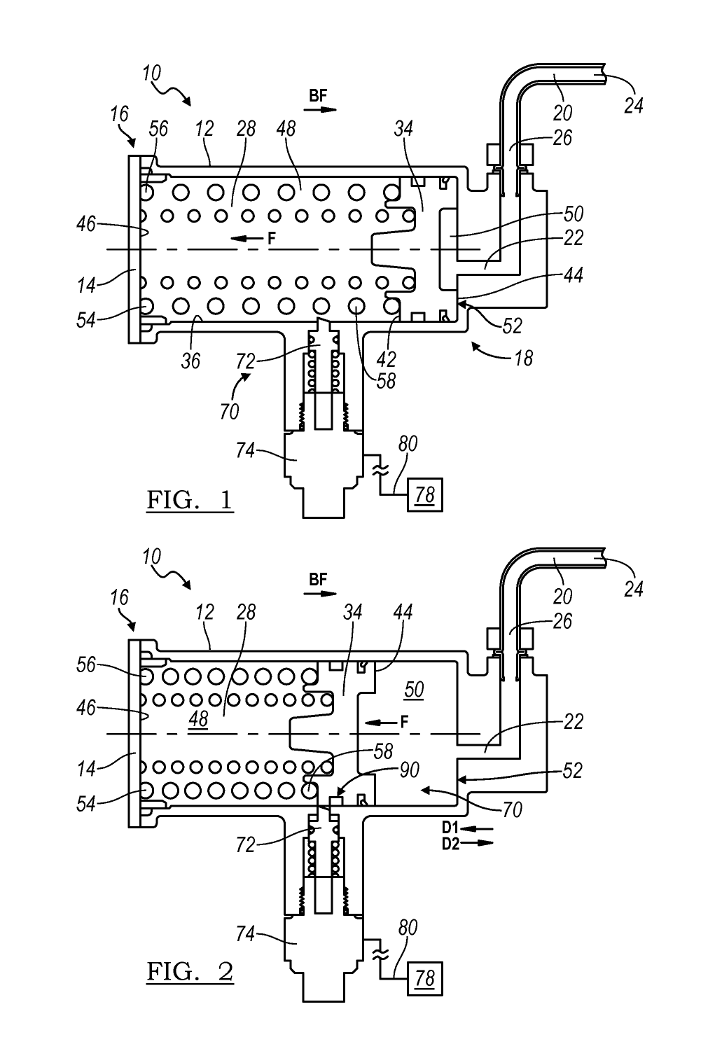

The cavity 22 of the pressure canister 12 defines a fluid pathway that fluidly connects the supply line 20 to the fluid chamber 50. Specifically, fluid either enters or exits from the fluid chamber 50. As fluid enters the first chamber 50, the pressure increases such that a force F is created. The force F created by the increased pressure of the fluid chamber 50 is greater than the biasing force BF. Turning now to FIG. 2, the force F exerted by the pressure of the fluid chamber 50 overcomes the biasing force BF, thereby urging the piston 34 to move in a first direction D1, towards the end cap 14. As fluid exits the fluid chamber 50, the fluid chamber 46 decreases in pressure such that the force F exerted by the fluid chamber 46 is now less than the biasing force BF, and the piston 34 is urged in a second direction D2 towards the end 52 of the canister 12 and returns to the seated position shown in FIG. 1.

Referring generally to FIGS. 1-2, a latching assembly 70 is operable to selectively retain hydraulic fluid in the fluid chamber 50 of the accumulator 10. Specifically, when the engine (not shown) is turned off, the latching assembly 70 is employed to retain hydraulic fluid within the fluid chamber 50. The latching device 70 includes an actuator 72, a solenoid valve 74, and the piston 34. Operation of the latching assembly 70 is controlled by a control module 78, where the control module 78 is connected to the solenoid valve 74 through an electrical connection 80. The control module 78 is used to supply electricity to the solenoid valve 74 depending on vehicle parameters such as engine operation or transmission torque or speed, and is preferably an electronic control device having a preprogrammed digital computer or processor, control logic, memory used to store data, and at least one I/O peripheral. The control logic includes a plurality of logic routines for monitoring, manipulating, and generating data.

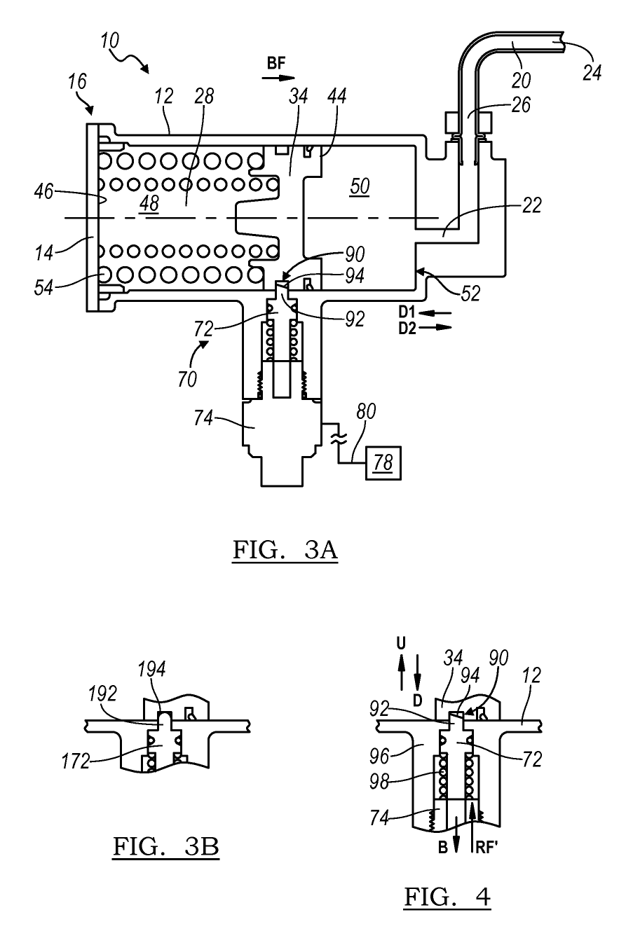

When the engine is operating, hydraulic fluid is communicated to the fluid chamber 50 through the supply line 20 through a passive valve (not shown) located upstream of the accumulator 10. The piston 34 is urged in the direction D1 until the actuator 72 engages with a circumferential groove 90 located on the sidewall of the piston 34. Specifically, turning now to FIGS. 3A and 4-5, the groove 90 is formed along the outer surface 44 of the piston 34. The groove 90 is sized to receive a distal end 92 of the actuator 72. The distal end 92 of the actuator 72 engages with and secures the piston 34 into a locked position as seen in FIG. 3A. In the locked position, the piston 34 is generally unable to slide along the inner surface 36 of the canister 12, thereby allowing hydraulic fluid to be retained within the fluid chamber 50. The biasing members 54 also include a stiffness that locks the piston 34 into the locked position. In the embodiment as shown in FIGS. 3A and 4-5, the distal end 92 of the actuator 72 includes an oblique surface or ramped profile 94. The ramped profile 94 allows for gradual engagement between the groove 90 and the distal end 92 of the actuator 72. Although a ramped profile 94 is illustrated in FIGS. 3A and 4-5, it is understood that other profiles may be used at the distal end 92 of the actuator 72. For example, FIG. 3B is an alternative embodiment of an actuator 172 having a distal end 192 that includes a rounded outer profile 194.

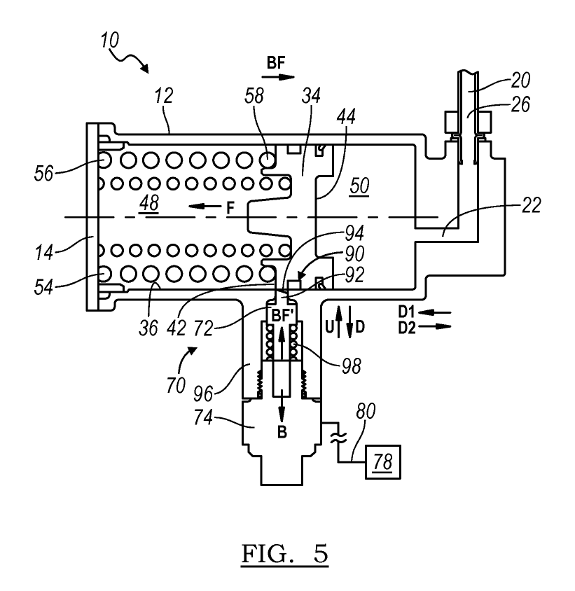

Referring now to FIGS. 4-5, the solenoid 74 includes a solenoid coil (not shown), where current is provided to the solenoid coil by the control module 78. The current flows through the solenoid coil to induce a magnetic field B. The magnetic field B actuates or moves the actuator 72 within a portion 96 of the pressure canister 12 where the actuator 72 is housed. Specifically, the magnetic field B causes the actuator 72 to move downwardly in a direction D when the magnetic field B is induced. The actuator 72 is constructed from any type of ferromagnetic material that responds to the magnetic field B such as, for example, an iron-based material, a nickel-based material, or a cobalt-based material. When electrical current no longer flows through the solenoid coil, the magnetic field B no longer exists, and the actuator 72 is no longer actuated in the direction D through the solenoid coil. Instead, a biasing member 98 seated within the portion 96 of the pressure canister 12 where the actuator 72 is housed is used to move the actuator 72. The biasing member 98 is situated between the actuator 72 and the solenoid 74. A biasing force BF′ exerted by the biasing member 98 urges the actuator 72 upwardly in a direction U. As the actuator 72 is urged in the direction U, the distal end 92 of the actuator 72 engages with the groove 90 located in the sidewall of the piston 34, which is shown in FIG. 4. When the solenoid coil of the solenoid 74 is activated, current flows through the solenoid coil to induce a magnetic field B to move the actuator 72 in the direction D. Moving the actuator 72 in the direction D disengages the actuator 72 with the groove 90 located on the piston 34, which is shown in FIG. 5. The control module 78 includes control logic for selectively providing current to the solenoid coil to induce the magnetic field B. When the solenoid coil is deactivated and the magnetic field B is no longer induced, the biasing member 98 urges the actuator 72 upwardly in the direction U, causing the actuator 72 to engage with the groove 90 located on the piston 34.

Referring generally to FIGS. 1-3A, the latching assembly 70 operates to accumulate hydraulic fluid within the fluid chamber 50 when the pressure upstream of the accumulator 10 is greater than the pressure of the fluid chamber 50, which occurs during operation of an engine or prime mover in a vehicle. That is, referring to FIGS. 1-2, the fluid chamber 50 will expand as the piston 34 slides along the inner surface 36 of the canister 12 in the direction D1. The piston 34 continues to slide in the direction D1 within the canister 12 until the groove 90 located along the outer surface 44 of the piston 34 engages with the distal end 92 of the actuator 72, which is shown in FIG. 3A. When the engine or prime mover is turned off, the piston 34 remains engaged with the actuator 72 in the locked position, thereby retaining hydraulic fluid within the fluid chamber 50.

When the vehicle is restarted, the control module 80 includes control logic for providing current to the solenoid coil to induce the magnetic field B. The actuator 72 is moved downwardly in the direction D (FIGS. 4-5), causing the actuator 72 to disengage from the groove 90 of the piston 34. The latching mechanism 70 is now unlocked, thereby allowing the biasing force BF exerted by the biasing members 54 to urge the piston 34 in the direction D2. As the piston 34 slides in the direction D2 within the canister 12, hydraulic fluid is discharged from the fluid chamber 50 and is sent through the supply line 20 to a control system of an automatic transmission (not shown).

Including the latching assembly 70 will allow for hydraulic fluid to be supplied to a clutch of an automatic transmission (not shown) during start up of a vehicle. This may be especially advantageous in a drivetrain where the engine or prime mover remains turned off during vehicle start up, and an electric motor propels the vehicle. Specifically, a transmission pump supplies pressurized hydraulic fluid from a sump to the clutches, however if the engine is not operating, the pump may be unable to supply fluid to the clutches. Instead, hydraulic fluid stored in the fluid chamber 50 of the accumulator 10 and released by the latching assembly 70 is used to supply fluid to the clutches.

The description of the invention is merely exemplary in nature and variations that do not depart from the gist of the invention are intended to be within the scope of the invention. Such variations are not to be regarded as a departure from the spirit and scope of the invention.

What is claimed is:

1. A latching hydraulic accumulator assembly comprising, in combination,
a cylindrical canister having an interior and a pair of ends, one of said ends defining a fluid passageway communicating with said interior,
a piston slidably disposed within said interior of said canister, said piston having a first side, a second side and a circumferential groove disposed between said sides,
biasing means disposed between another of said ends and said first side of said piston, and
a two position actuator for selectively engaging said circumferential groove in said piston,
whereby in a first position of said actuator, said piston is free to translate and in a second position of said actuator, said piston is locked against translation.

2. The latching hydraulic accumulator assembly of claim 1 wherein said actuator includes a solenoid.

3. The latching hydraulic accumulator assembly of claim 1 wherein said actuator is a plunger of a solenoid.

4. The latching hydraulic accumulator assembly of claim 1 wherein said actuator is ramped.

5. The latching hydraulic accumulator assembly of claim 1 wherein said means for biasing includes at least one compression spring.

6. The latching hydraulic accumulator assembly of claim 1 wherein said means for biasing includes two compression springs.

7. The latching hydraulic accumulator assembly of claim 1 wherein said one of said ends is integrally formed with said cylindrical canister and said another of said ends is a cap.

8. A latching hydraulic accumulator comprising, in combination,
a cylinder having an interior, a first end and a second end, said first end including a cap and said second end defining a fluid passageway communicating with said interior,
a piston slidably disposed within said interior of said cylinder, said piston having a first side, a second side and a circumferential groove disposed between said sides,
biasing means disposed between said first end and said first side of said piston, and
an actuator for selectively engaging said circumferential groove in said piston.

9. The latching hydraulic accumulator of claim 8 wherein said second end is integrally formed with said cylindrical canister.

10. The latching hydraulic accumulator of claim 8 wherein said means for biasing includes at least one compression spring.

11. The latching hydraulic accumulator of claim 8 wherein said means for biasing includes two compression springs.

12. The latching hydraulic accumulator of claim 8 wherein said actuator includes a solenoid.

13. The latching hydraulic accumulator of claim 8 wherein said actuator is a plunger of a solenoid.

14. The latching hydraulic accumulator of claim 8 wherein said actuator is ramped.

15. The latching hydraulic accumulator of claim 8 wherein said piston includes a sidewall and said circumferential groove is disposed in said sidewall.

16. A latching hydraulic accumulator assembly comprising, in combination,
a cylindrical canister having an interior, a first end and a second end, said first end including a cap and said second end defining a fluid passageway communicating with said interior,
a piston slidably disposed within said interior of said cylindrical canister, said piston having a first face, a second face and a circumferential groove disposed between said faces,
at least one compression spring disposed between said first end and said first face of said piston, and
a two position actuator and solenoid for selectively engaging said circumferential groove in said piston and inhibiting translation of said piston.

17. The latching hydraulic accumulator assembly of claim 16 wherein said actuator includes an oblique surface.

18. The latching hydraulic accumulator assembly of claim 16 wherein said second end of said cylindrical canister is integrally formed with said canister.

19. The latching hydraulic accumulator assembly of claim 16 wherein said piston includes a sidewall and said circumferential groove is disposed in said sidewall.
